(19) United States
(12) Patent Application Publication
(10) Pub. No.: US 2017/0237328 A1
(43) Pub. Date: Aug. 17, 2017

(54) Magnetic Power Generator

(71) Applicant: Yen-Hwang Chiang, Taipei (TW)

(72) Inventor: Yen-Hwang Chiang, Taipei (TW)

(21) Appl. No.: 15/045,260

(22) Filed: Feb. 17, 2016

(51) Int. Cl. H02K 35/02

(52) U.S. Cl. CPC H02K 35/02

(57) ABSTRACT

A power generator composing of a plurality of magnetic oscillators connected in series for producing electricity in a cheaper way and is more environmentally friendly for producing a clean energy. The magnetic oscillators may also be implemented to be a magnetic transformer.

### BACKGROUND OF THE INVENTION

U.S. Pat. No. 6,982,501 disclosed a magnetic fluid power generating device for generating power, which includes a fluid containing magnetic particles. A source magnetizes the fluid thereby including rotations in the magnetic particles for creating a magnetic flux. The rotations of the magnetic particles induce an electromagnetic force in a coil associated with the fluid. The device including the magnetic fluid MF, alternating and traveling magnetic fields 22, pump 16, reservoir 18, non-magnetic and non-conductive loop of tubing 20, permanent DC magnet 24, and external pickup coils 26 acts as an electric power generator.

However, this prior art requires complex elements and operations, having, difficulties for commercialization thereof.

### SUMMARY OF THE INVENTION

The object of the present invention is to provide a power generator composed of a plurality of magnetic oscillators connected in series for producing electricity in a cheaper way and is more environmentally friendly for producing a clean energy. The magnetic oscillators may also be implemented to be a magnetic transformer.

### BRIEF DESCRIPTION OF THE DRAWINGS

FIG. 1 shows an individual magnetic oscillator in accordance with the present invention.

FIG. 2A shows a first magnetic path in accordance with the present invention.

FIG. 2B shows a second magnetic path in accordance with the present invention.

FIG. 2C shows a third magnetic path in accordance with the present invention.

FIG. 3 shows a magnetic transformer circuit composed of a plurality of magnetic oscillators in accordance with the present invention.

FIG. 4 is an illustration showing the equivalent magnetic paths as derived from FIG. 3 in accordance with the present invention.

FIG. 5A shows a first magnetic path of FIG. 3 for a first half wave of an alternating-current sine-wave signal.

FIG. 5B shows a second magnetic path of FIG. 3 for a second half wave of an alternating-current sine-wave signal as opposite to the first half wave of the sine-wave signal.

FIG. 6 shows another preferred embodiment of magnetic power generator in accordance with the present invention.

### DETAILED DESCRIPTION

As shown in FIG. 1, the present invention comprise a magnetic oscillator 1, of which a plurality of said magnetic oscillators 1 can be connected in series to form a magnetic power generator in accordance with the present invention.

The magnetic oscillator 1 as shown in FIG. 1 comprises: at least a magnetic conductive element 11 which may be made of silicon-steel sheets or plates, a pair of permanent magnets 12, 13 having opposite magnetic poles to each other (for instance, the permanent magnet 12 having N, S poles, while the permanent magnet 13 having S, N poles opposite to that of permanent magnet 12) disposed on opposite sides of a magnetic core 111 of the magnetic conductive element 11 centrally defined between two connecting ends of the element 11, an output coil 14 wound around the core 111 for outputting power from the magnetic oscillator 1, and an input coil 15 wound around a loop 151 connected across opposite ends 11a, 11b of the magnetic conductive elements 11 for inputting alternating-current sine-wave signals into the magnetic oscillators 1.

Plural thermal insolating members or plates (e.g., made of paper) 121, 131 are provided to insulate the magnets 12, 13 from the magnetic conductive element 11.

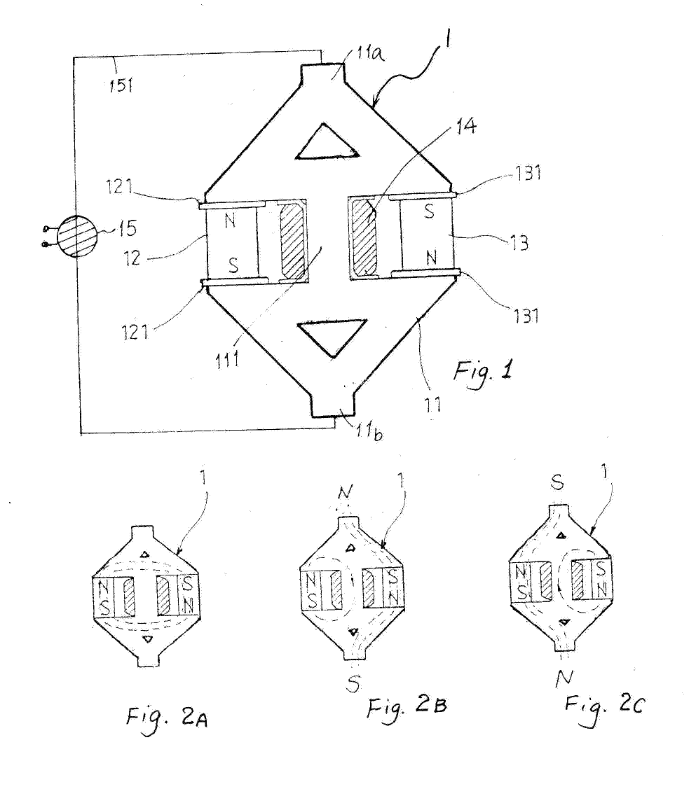

As shown in FIGS. 2A, 2B and 2C, three magnetic paths are presented in accordance with the present invention. Each magnetic path as shown in dotted line is directed from N pole to S pole. Each magnetic path for flowing magnetic flux therethrough will induce electric current through each coil 14 wound around each core 111 for outputting the electric current or electricity outwardly.

The input coil 15 will be directed therein an alternating current sine wave signals such as 60 HZ or 60 cycles per second. Since each input coil 15, as being conducted therein with the alternating current, an electromagnet will thus be formed, equivalent to a magnet, having a north (N) pole and a south (S) pole alternatively created or induced by each half wave of each sine-wave signal of the input alternating current.

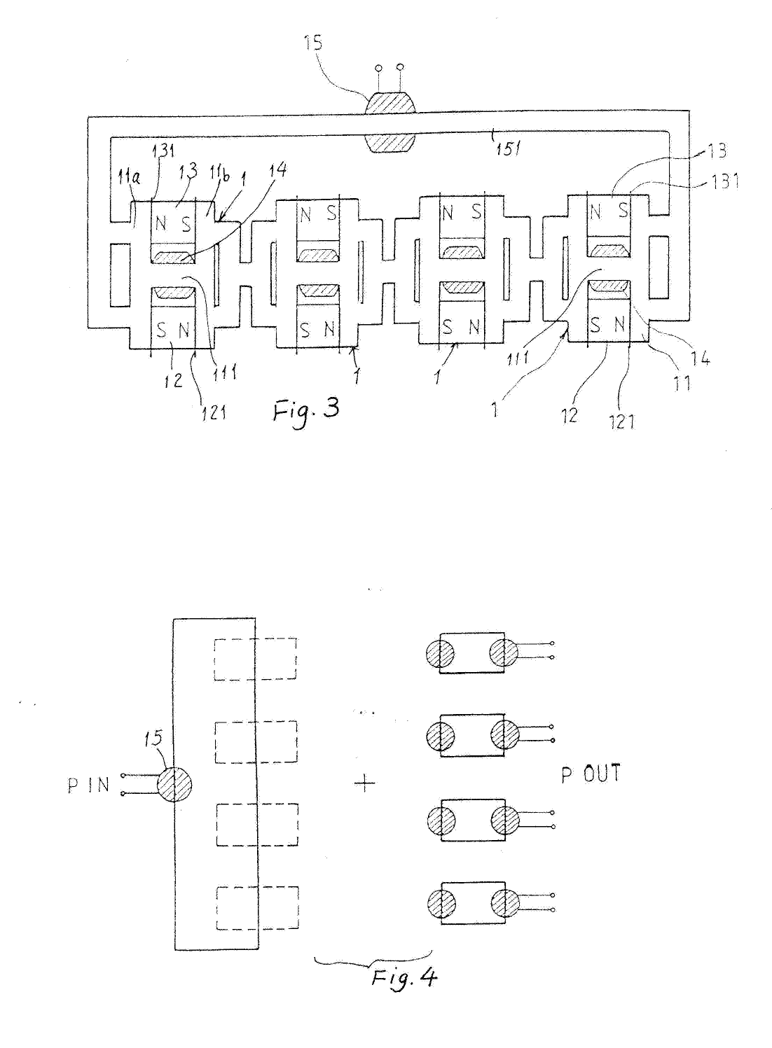

Accordingly, each half wave of each sine-wave signal of the alternating current input into the coil 15 will alternatively produce a pair of S, N poles as shown in FIG. 5A or a pair of N, S poles as shown in FIG. 5B as opposite to or reversed from that as shown in FIG. 5A. Both FIGS. 5A and 5B are derived from the magnetic circuit as shown in FIG. 3, in which the input coil 15 will play a role as an electromagnet to produce N, S poles or S, N poles alternatively.

In FIG. 4, an illustration showing each equivalent magnetic path of the magnetic circuit as shown in FIG. 3 is inferentially “broken down” for an easy explanation and understanding of the equivalent magnetic path as effected by the present invention. On the left side of FIG. 4, a power input Pin (without output coil) is illustrated to indicate a long magnetic path across the input coil 15.

On the right side of FIG. 4, a power output Pout is illustrated indicating the electric powder as output through each output coil provided in each magnetic oscillator of the present invention.

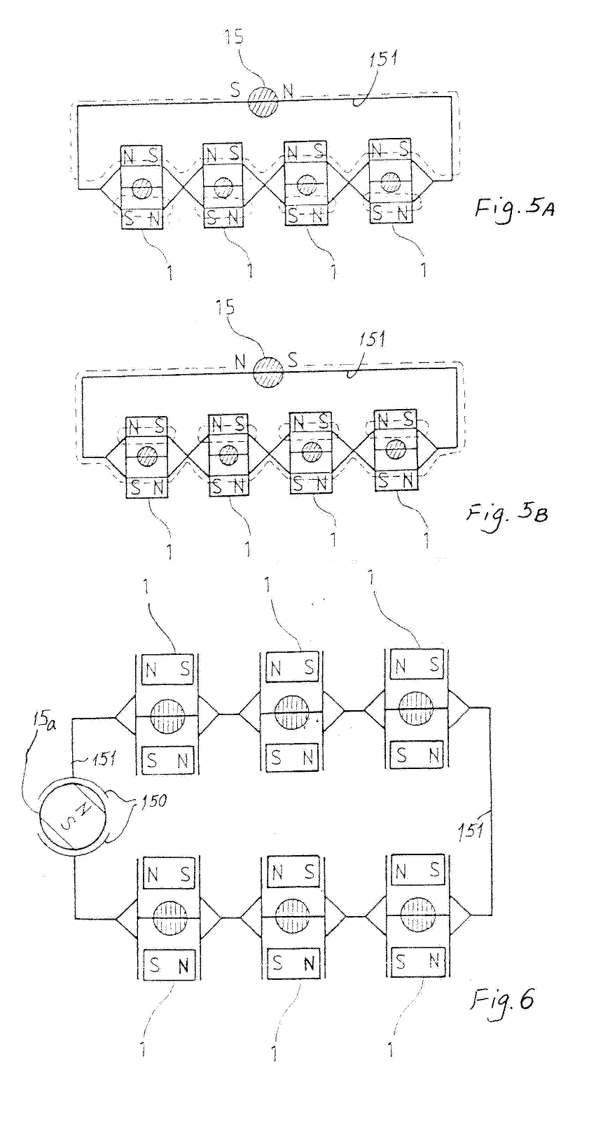

As shown in FIG. 6, the input coil 15 may be substituted with a magnetic rotor 15a which includes a pair of N, S poles and is rotatably driven, such as driven by a wind turbine or any other rotating devices, for alternatively changing the N, S poles. A pair of ferromagnetic yokes 150 are disposed about the magnetic rotor 15a for inducing the polarities from the magnetic rotor 15a so as to alternatively produce N, S-pole signals to be transmitted through the magnetic path (N-S-N-S . . . ) as formed by connecting the magnetic oscillators 1 in series.

As shown in FIG. 3, when either half-wave of the sine-wave signal of the alternating current as led into the input coil 15 is transmitted through the magnetic path of the magnets 12 or 13 (N-S-N-S . . . ), an electric current will be induced and output by each output coil 14 as wound around the core 111 of each magnetic oscillator 1 to output power. Since each sine wave includes a positive half wave and a negative half wave, a positive half wave will pass through a first magnetic path, such as shown in FIG. 5A, to exert a first output current; while a negative half wave will pass through a second magnetic path such as shown in FIG. 5A, a reverse direction opposite to that of FIG. 5A. Therefore, either positive half wave or negative half wave will produce output current continuously alternatively, thereby increasing the output electric energy.

As shown in FIG. 3, four magnetic oscillators 1 are connected in series to thereby output energy as multiplied for four times from the input energy.

For example, if the magnetic energy of one magnetic oscillator 1 is 100 watts, and the conversion efficiency is 98% by converting the magnetic energy into electric energy. The four magnetic oscillators 1 as connected in series will then output 392 watts (98 W×4=392 W). Therefore, the present invention will multiplify the output electric energy once connecting a plurality of magnetic oscillators 1 of the present invention.

The present invention may therefore provide of a magnetic power generator or a magnetic transformer for boosting, increasing or multiplifying the input energy.

Although the silicon steel sheet for forming the magnetic conductive element 11 of the magnetic oscillator 1 may be H shape, other shapes may also be modified, not limited in this invention.

The present invention may be modified without departing from the spirit and scope of the present invention.

I claim:

1. A magnetic power generator comprising:
a plurality of magnetic oscillators connected in series;
an input coil wound around a loop connected across a pair of magnetic paths juxtapositionally formed through said magnetic oscillators as connected in series for inputting alternating-current sine-wave signals into the loop;
each said magnetic oscillator including: a magnetic conductive element centrally defining a magnetic core between two connecting ends of the magnetic conductive element, a pair of permanent magnets having opposite magnetic poles to each other disposed on opposite sides of the magnetic core, an output coil wound around the magnetic corer for outputting electric current as induced by a flux flowing through each magnetic path through the magnetic oscillators: whereby upon transmitting a first half wave of one said sine wave signal from said input coil, a first electric current will be induced by a first magnetic path formed through a first set of said permanent magnets, and output by each said output coil of each said magnetic oscillator; and
upon transmitting a second half wave of one said sine wave signal from said input coil, a second electric current will be induced by a second magnetic path formed through a second set of said permanent magnets and output by each said output coil of each said oscillator, to thereby generate electricity.

2. A magnetic power generator according to claim 1, wherein each said permanent magnet is spaced from each said magnetic conductive element by thermal insulating members.

3. A magnetic power generator according to claim 1, wherein said magnetic conductive element is made of silicon steel sheets.

4. A magnetic power generator comprising:
a plurality of magnetic oscillators connected in series;
a magnetic rotor having N pole and S pole disposed on opposite ends thereof for producing alternating since-wave signals and rotatably defing between two ferromagnetic yokes connected to a loop connected across a pair of magnetic paths juxtapositionally formed through said magnetic oscillators as connected in series for inputting alternating sine-wave signals into the loop;
each said magnetic oscillator including: a magnetic conductive element centrally defining a magnetic core between two connecting ends of the magnetic conductive element, a pair of permanent magnets having opposite magnetic poles to each other disposed on opposite sides of the magnetic core, an output coil wound around the magnetic core for outputting electric current as induced by flux flowing through each magnetic path through the magnetic oscillators; whereby upon transmitting a first half wave of one said sine wave signal from said magnetic rotor, a first electric current will be induced by a first magnetic path formed through a first set of said permanent magnets, and output by each said output coil of each said magnetic oscillator; and
upon transmitting a second half wave of one said sine wave signal from said magnetic rotor, a second electric current will be induced by a second magnetic path formed through a second set of said permanent magnets and output by each said output coil of each said oscillator, to thereby generate electricity.
